(19) United States
(12) Patent Application Publication
(10) Pub. No.: US 2026/0329001 A1
(43) Pub. Date: Oct. 22, 2026

(54) OPTICAL PHASED ARRAY GRATINGS BASED ON EXTREME SKIN-DEPTH METAMATERIAL WAVEGUIDES

(71) Applicant: Purdue Research Foundation, West Lafayette, IN (US)

(72) Inventors: Zubin Jacob, West Lafayette, IN (US); Saman Jahani, Stamford, CT (US)

(73) Assignee: Purdue Research Foundation, West Lafayette, IN (US)

(21) Appl. No.: 19/116,882

(22) PCT Filed: Oct. 2, 2023
(86) PCT No.: PCT/US2023/034328

§ 371 Date: Mar. 28, 2025

Related U.S. Application Data
(60) Provisional application No. 63/412,018, filed on Sep. 30, 2022.

(51) Int. Cl. G02B 6/12; G02B 5/18; G02B 6/122; G02B 6/125

(52) U.S. Cl. CPC G02B 6/12019; G02B 5/1809; G02B 6/1223; G02B 6/125; G02B 2006/12038; G02B 2006/12142; G02B 2006/1215

(57) ABSTRACT

An optical waveguide may include a core that is substantially transparent at an operating wavelength. The core may extend along a longitudinal direction. The optical waveguide may further include a cladding positioned on either side of the core. The cladding may include a plurality of layers, and each layer may extend along the longitudinal direction. At least one of the layers may include a plurality of elongated rods of a high index semiconductor. A gap may be defined between respective ends of the rods.

### CROSS REFERENCE TO RELATED APPLICATIONS

This application claims the benefit of U.S. Provisional Application No. 63/412,018 filed Sep. 30, 2022, the entirety of which is hereby incorporated by reference.

### GOVERNMENT RIGHTS

This invention was made with government support under DMR 1654676 awarded by the National Science foundation. The government has certain rights in the invention.

### TECHNICAL FIELD

This disclosure relates to optical waveguides and, in particular, to beamform using optical waveguides.

### BACKGROUND

Optical phased array (OPA) is the optical analogy of radio-wave phased array which can be used for beam steering without any moving parts. By dynamically modulating the phase of each optical radiating element (optical antenna) and using a single frequency coherent laser, beamforming may be performed in one or two dimensions using 1D or 2D OPAs, respectively. If each optical antenna is made as a 1D grating and the optical source is broadband, even a 1D array can form a beam in two dimensions. The beam width in one dimension is limited by the bandwidth of the source and it is limited in the other direction by the spacing between the optical elements (optical antenna pitch).

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a cross section view of a single waveguide.

FIG. 2. illustrates a perspective view of coupled waveguides in an optical phased array.

FIG. 3A-B shows various dimensions and attributes of a single e-ski waveguide and their effect on the effective index of the wave guide.

FIG. 4 illustrates an example of an optical phased array system.

FIG. 5 illustrates an example of an optical phased array system with bends in the waveguides.

FIG. 6 illustrates a top view of an optical phased array with uniform layers.

FIG. 7 illustrates a top view of a first example of an optical phased array with non-uniform cladding.

FIG. 8 illustrates a top view of a second example of an optical phase array with non-uniform cladding.

FIG. 9 illustrates an example of coupling length as a function of the center to center separation (pitch), of two adjacent waveguides.

### DETAILED DESCRIPTION

Based on the grating equation, the relationship between the incident angle and the diffracted angle is defined as:

$$sin sin {θ}_{i} - sin sin {θ}_{m} = m \frac{λ}{Λ} ,$$

where m is the diffraction order, θᵢ and θₘ are the incident angle and the diffraction angle of the m^{th} order, respectively, λ is the wavelength of the laser source, and Λ is the grating period. To avoid the diffraction of higher orders while scanning the entire 180 degree, the grating period (optical antenna pitch) must be less than λ/2. The diffraction of higher grating orders creates unwanted lobes which limit the field of view. However, dense packing of conventional optical radiating elements causes significant crosstalk between adjacent elements which limits the OPA efficiency. Hence, there is a trade-off between the field of view and the beamforming efficiency in conventional OPAs.

Index mismatched waveguides to reduce crosstalk between adjacent waveguides is emerging though presently rife with problems. Even though this approach is successful to reduce the crosstalk, it is very sensitive to the fabrication imperfection. Also, because of the index-mismatch between waveguides, the phase velocity in each optical element is different which impedes 2D beamforming. In addition, because each element has a different shape, the radiation efficiency of optical elements is nonuniform. Hence, implementing this approach into practice is very challenging.

This disclosure provides, according to the various embodiments, a new approach for achieving low crosstalk OPA grating based on extreme skin-depth (e-skid) waveguides to do beamforming with a broad field of view in 2 dimensions. A previous work, U.S. Pat. No. 9,274,276B2, which has incorporated by reference herein, it was shown that using the extra degree of freedom in anisotropic media allows us to control the evanescent waves and reduce the crosstalk in closely packed array of waveguides.

Table 1 shows the measured crosstalk of embodiments described herein compared to other approaches for reducing crosstalk in integrated photonic circuits. The examples according to the disclosure provided herein not only demonstrates the lowest crosstalk, but also provides the lowest propagation loss compared to the other techniques proposed for reducing the crosstalk. Since the size of each optical antenna is few hundreds of microns, high propagation loss reduces the radiated power which is a limiting factor for many applications, such as LiDAR where low power operation is extremely desired. Besides, as we have shown in our previous paper, e-skid waveguide can confine only TE-like modes. Hence, the absorption efficiency for TM-like modes is extremely low which is desirable for LiDAR applications which require single polarization operation.

TABLE 1
Performance comparison between an extreme skin−depth
(e−skid waveguide) and other dielectric waveguides.

| Reference | Crosstalk | Propagation Loss |
|---|---|---|
| Superlattice | −20 dB | >20 dB/cm |
| Adiabatic elimination | −21.9 dB | N/A |
| Inverse Design | −22.9 dB | >300 dB/cm |
| Dissimilar waveguides | −20 dB | N/A |
| Sinusoidal waveguides | −26.8 dB | >600 dB/cm |
| This work (e−skid) | −30 dB | 3.67 dB/cm |

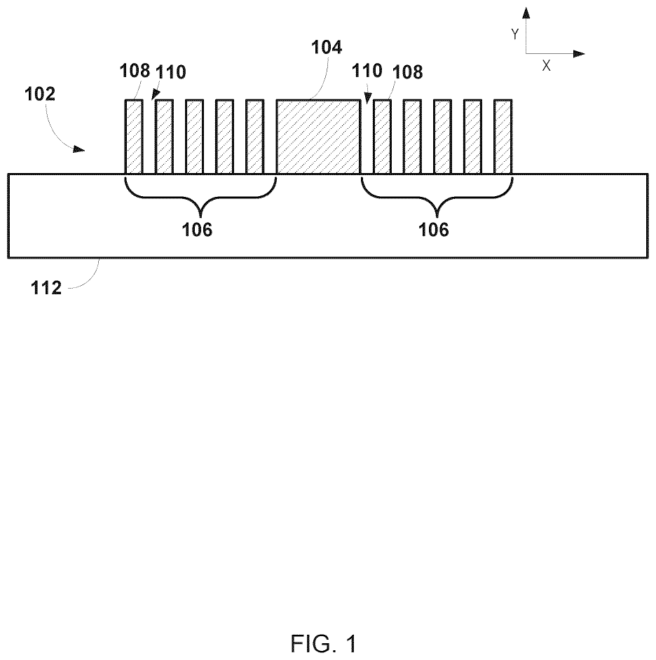

FIG. 1 illustrates a cross section view of a single e-skid waveguide 102. The waveguide 102 may include a core 104. The core 104 may include a material that is that is substantially transparent an operating wavelength. By way of non-limiting-example, the material of the core 104 may be silicon (Si), silicon nitride (SiN), or Lithium Niobate (LN). The core 104 may extend along a longitudinal direction (perpendicular to the X and Y vectors shown in FIG. 1). The waveguide 102 may include a cladding positioned on either side of the core. The cladding may include a plurality of layers, each layer positioned outward from the core in a direction substantially perpendicular to the longitudinal direction.

The layers may alternate between a high index layer 108 and a lower index layer 110. The high index layer(s) may include a high-index substance. Examples of such materials may include Si, SiN, LN or Aluminum Nitride (AlN). The high-index layer may or may not be the same substance as the core.

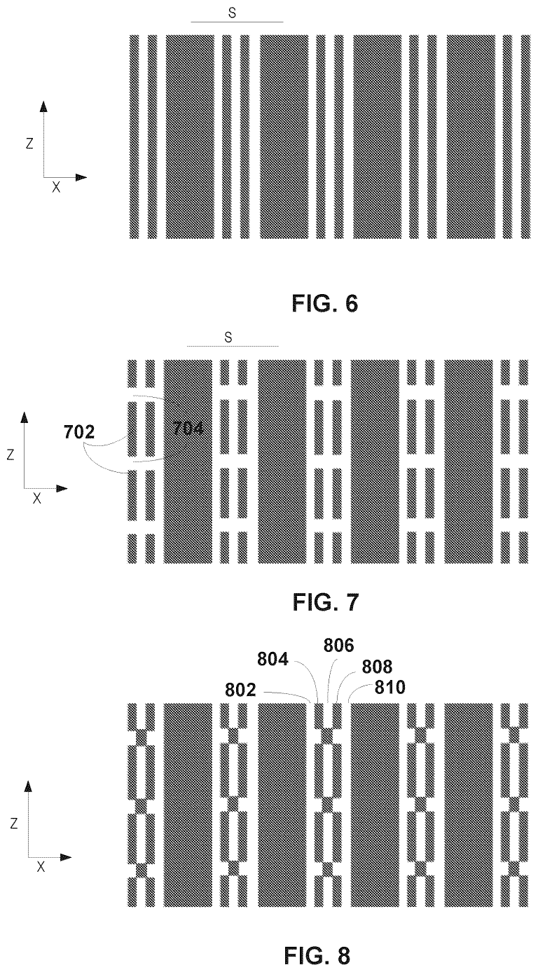

The low index layer(s) may include a low-index substance. Examples of such materials include of air, silica, porous silica, or polymers. The contrast between the high index and the low index multilayer leads to an effective anisotropy in the cladding. The layers of the cladding may be uniform or non-uniform along the longitudinal direction. Various examples of the cladding are shown in FIGS. 6-8.

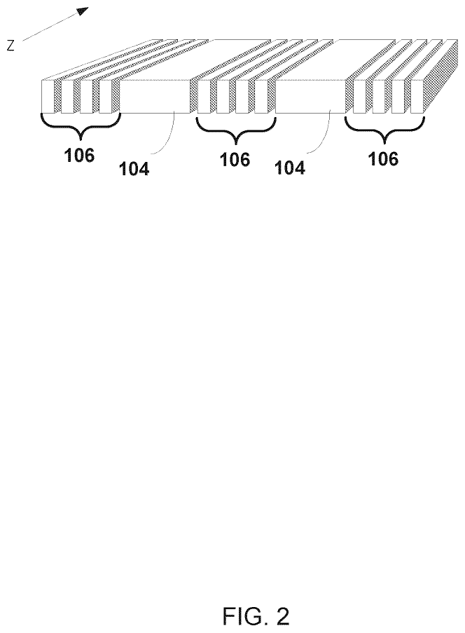

FIG. 2. illustrates a perspective view of coupled e-skid waveguides in an optical phased array. As we mentioned earlier, for beam formation in 2 dimensions, the waveguide may be designed as a grating. The grating also helps to improve the coupling efficiency into the free space. To make the waveguide as a grating, the effective index of each waveguide should change periodically. To have an efficient radiation efficiency and to reduce the aberration, the antenna length has to be hundreds of micrometers. For such a long length, the propagation loss is required to be extremely low. A sudden change in the waveguide effective index can add significant propagation loss, but gradual change in the waveguide geometry in conventional structure is challenging because of the fabrication limitations. In e-skid waveguides, the change in effective index of the waveguides is less sensitive to the variation of the cladding.

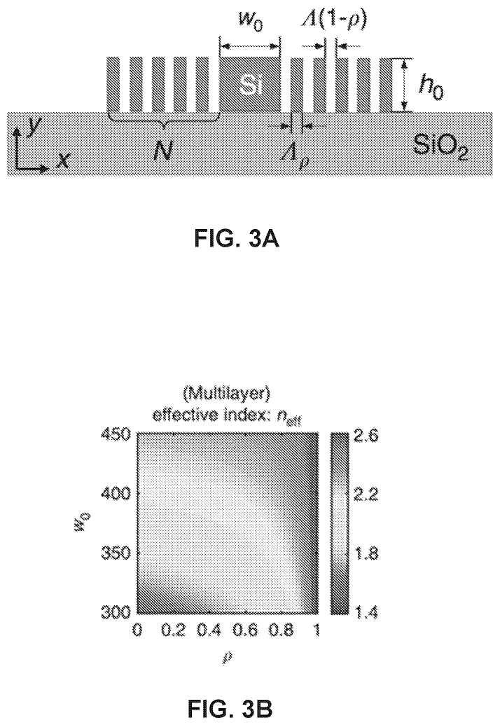

FIG. 3A-B shows various dimensions and attributes of a single e-ski waveguide and their effect on the effective index of the wave guide. FIG. 3A shows various dimensions of a wave guide. As shown in FIG. 3B, the effective index is very sensitive to the waveguide width variation, but it is not very sensitive to the cladding variation. This can help to make gratings with very low propagation loss which are amenable to fabrication imperfections.

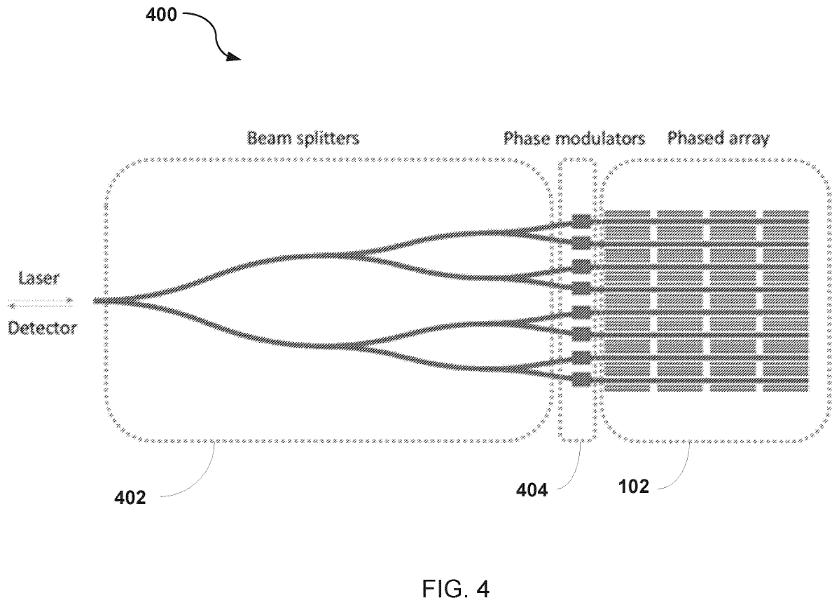

FIG. 4 illustrates an example of an optical phased array system 100. The optical phased array system may be a receiver or transmitter. The system may include beam splitter(s) 402, phase modulators(s) 404, and the optical phased array 102.

For transmitter embodiments, the input beam from the laser is divided into multiple waveguides. The phase modulators 404 modulate the phase of each optical mode, and then the optical phased array 102 emits the signal to free space to the desired direction based on the phase distribution. When it works as a receiver, the incident beam is collected by the phased array 102 and phase modulators 404 correct the phase to make sure we are collecting from the desired direction and then the powers are combined and sent to the detectors (not shown in FIG. 4).

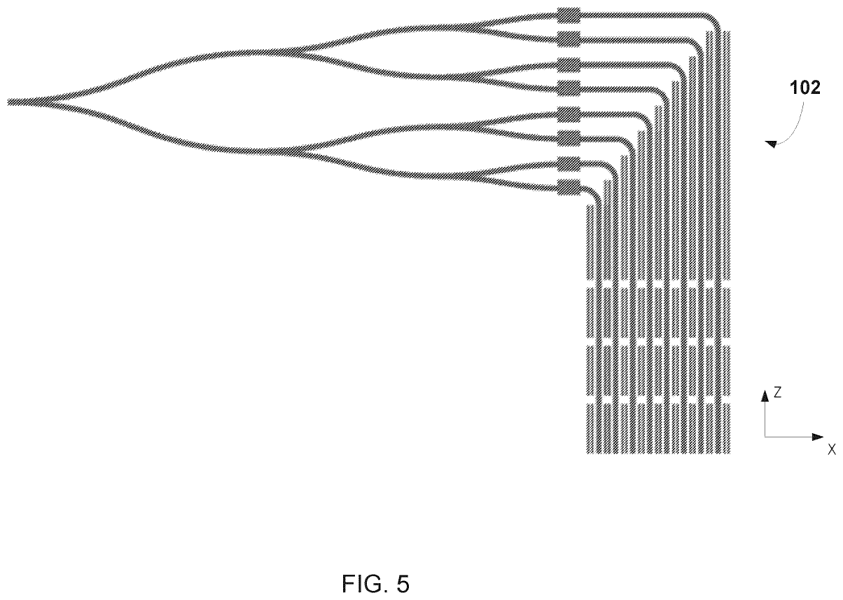

FIG. 5 illustrates an example of an optical phased array system with bends in the waveguides. To reduce the antenna pitch, the phased array 102 may have bends in each waveguide branch. For example, the core may bend at, for instance, a 90 degree angle or some other angle. Also, delay lines (waveguides with different length) can be added to each waveguide to make sure each antenna has the same length. For instance, the cladding and cores of the waveguide shown in FIG. 5 are each different lengths along the longitudinal direction Z and causing each waveguide to become progressively longer along the lateral X direction.

FIG. 6 illustrates a top view of an optical phased array with uniform layers along the longitudinal direction Z. The center-to-center separation, or pitch, (S) between cores may be as low as half a wavelength. The optical phased array includes a wave guide with a cladding positioned on either side of the core. The cladding includes a plurality of layers. Moving in a lateral direction X, perpendicular to the longitudinal direction Z, each of the layers may alternate between a high-index layer and a low-index layer. Each layer may extend along the longitudinal axis.

The high-index layer may include an elongated rods of a high index semiconductor. The low-index layer may include an elongated rod of a low-index semiconductor.

Here, the layers of the cladding alternate between a high index material and a lower index material. The center-to-center separation can be as low as half a wavelength. Since there is no grating the outcoupling is weak and the beamforming in second dimension is not possible. A low index material may be periodically deposited on top of the waveguides, the beamforming can happen in 2D.

FIG. 7 illustrates a top view of the first example of an optical phased array with non-uniform cladding. In this example, one or more of the layers may include multiple rods 702. Each of the rods may extend between a first and second end. A plurality of gaps 704 are defined between the ends of the rods such that the layer alternates between rods and gaps along the longitudinal length Z of the waveguide.

By periodically removing portions of cladding in a small region of OPA, light may be efficiently outcoupled to the free space. However, removing the cladding might cause crosstalk between waveguides.

FIG. 8 illustrates a top view of a second example of an optical phase array with non-uniform cladding. To avoid the crosstalk while modulating the effective index of the waveguide, we can change the periodicity of the cladding and the number of rods in the cladding. As illustrated in FIG. 8, the cladding may have multiple layers. A first layer 802 may be a low-index layer. A second layer 804 may have gaps defined by high-index rods at a first periodicity. A third layer 806 may have gaps defined between the high-index rods at a second periodicity. A fourth layer 808 may have gaps defined at the first periodicity. A fifth layer 810 may be a low-index layer.

To describe another way, the high-index rods of the second layer may each be the same length as the high-index rods of the fourth but different than the high-index rods of the third layer.

These Manhattan-like structures have pixel sizes larger than what is used in conventional lithography. Thus, they can be fabricated using a single etch lithography even if the center-to-center separation between waveguides (antenna pitch) is around half a wavelength. This approach is not limited to e-skid waveguides. We can periodically add rods to the cladding of strip waveguides to make a grating. In this approach instead of periodically removing the cladding, we are periodically adding a cladding. The waveguide material is not restricted to silicon. As long as there is a high contrast in the refractive index between the waveguide material and the surrounding media, the e-skid waveguide can control the evanescent fields to reduce the crosstalk between the optical elements. The waveguide can be made of SIN and LN as well.

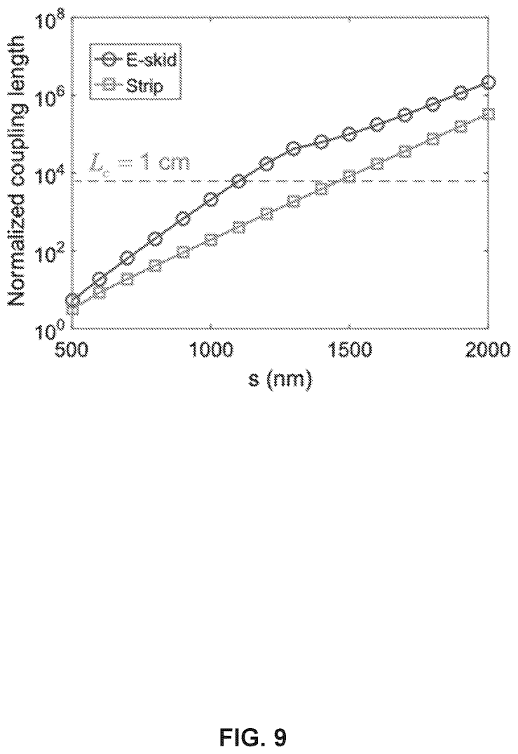

FIG. 9 illustrates an example of coupling length as a function of the center to center separation (pitch), S, of two adjacent waveguides. Coupling length is the length that is required to transfer the entire power in one waveguide to the adjacent waveguide. For e-skid waveguides, the coupling less can be an order of magnitude longer (which means less coupling for a fixed length). This allows achieving a densely packed optical phased array using e-skid waveguides.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations. The following references are used as further background and supporting information for the system, waveguide, and methods described herein.

What is claimed is:

1. An optical waveguide comprising:
a core that is substantially transparent at an operating wavelength, the core extending along a longitudinal direction; and
a cladding positioned on either side of the core, the cladding comprising a plurality of layers, each layer extending along the longitudinal direction, wherein at least one of the layers comprises a plurality of elongated rods of a high index semiconductor, wherein a gap is defined between respective ends of the rods.

2. The optical waveguide of claim 1, wherein a low index material and/or gas is disposed between in the gap.

3. The optical waveguide of claim 2, wherein the low index material comprises one or more of air, silica, porous silica, or polymer.

4. The optical waveguide of claim 1, wherein the high-index semiconductor comprises Si, SiN, AlN or LN.

5. The optical waveguide of claim 1, wherein the core comprises Si, SiN, AlN or LN.

6. The optical waveguide of claim 2, wherein a width of each layer is less than the operating wavelength.

7. The optical waveguide of claim 1, wherein each layer comprises a plurality of gaps defined by each of the ends of the rods such that the layer alternates between rods and gaps along the longitudinal length of the waveguide.

8. The optical waveguide of claim 7, wherein rods of a first layer define the gaps at a first periodicity and a rods of a second layer define gaps at a second periodicity.

9. An array of the waveguides, comprising:
a plurality of cores that is substantially transparent at an operating wavelength; and
cladding positioned on either side of the cores, wherein the pitch between the cores is less than the operating wavelength.

10. The array of waveguides of claim 1, wherein the cladding comprises a plurality of layers, each layer extending along a longitudinal direction, wherein at least one of the layers comprises a plurality of elongated rods of a high index semiconductor, wherein a gap is defined between respective ends of the rods.

11. The array of the waveguides of claim 10, wherein a low index material and/or gas is disposed between in the gap.

12. The array of the waveguides of claim 10, wherein the low index material comprises one or more of air, silica, porous silica, or polymer.

13. The array of the waveguides of claim 10, wherein the high-index semiconductor comprises Si, SiN, AlN or LN.

14. The array of the waveguides of claim 10, wherein a width of each layer is less than the operating wavelength.

15. The array of the waveguides of claim 10, wherein each layer comprises a plurality of gaps defined by each of the ends of the rods such that the layer alternates between rods and gaps along the longitudinal length of the waveguide.

16. The array of the waveguides of claim 15, wherein rods of a first layer define the gaps at a first periodicity and a rods of a second layer define gaps at a second periodicity.

17. The array of the waveguides of claim 9, wherein the cores comprise Si, SiN, AlN or LN.

18. The array of waveguides of claim 9, wherein the pitch between the cores is less than or equal to half of the operating wavelength.
